(19) United States
(12) Patent Application Publication
(10) Pub. No.: US 2010/0237160 A1
(43) Pub. Date: Sep. 23, 2010

(54) SHOWER DEVICE WITH INDEPENDENTLY OPERATING VALVES

(76) Inventors: Michael A. Miller, Portage, MI (US); Julian Giggs, Hillsdale, MI (US); Lizhong Liao, Xiamen (CN); Shengjun Du, Xiamen (CN)

Correspondence Address: Carlson, Gaskey & Olds/Masco Corporation, 400 West Maple Road, Suite 350, Birmingham, MI, 48009, US

(21) Appl. No.: 12/407,136

(22) Filed: Mar. 19, 2009

(51) Int. Cl. B05B 1/16

(52) U.S. Cl. 239/1; 239/443

(57) ABSTRACT

A shower device includes spray outlets and valves configured to control flow of a fluid to the spray outlets. At least one of the valves is configured to control, independently of other valves, flow of the fluid to at least one of the spray outlets.

### BACKGROUND OF THE INVENTION

This disclosure relates to shower devices and, more particularly, to a shower device and method for controlling a spray pattern from spray outlets of the shower device.

Many shower devices contain a single set of spray outlets in a specific configuration to provide a desired spray pattern. Other shower devices are adjustable to provide different spray patterns, depending on preferences of a user. One such shower device includes a shower head having multiple spray outlets arranged on a face plate and a water supply passage, to control flow of water to the spray outlets. A user may turn a dial on the shower head to divert water to sections of the spray outlets to provide a desired spray pattern.

Although effective, such shower devices are typically limited to a few spray patterns provided by the multiple outlets on the face plate. Thus, the manufacturer pre-selects the spray patterns for a user to choose from, and the user has no ability to adjust the given spray patterns based upon their own preferences.

### SUMMARY OF THE INVENTION

An example shower device includes spray outlets and valves configured to control flow of a fluid to the spray outlets. At least one of the valves is configured to control, independently of other valves, flow of the fluid to at least one of the spray outlets.

In another aspect, a shower device includes operable valves, and actuation of any one of the operable valves causes that operable valve to unlock from a locked state, move from a first position or a second position to, respectively, the second position or the first position, and then relock to the locked state.

An example method of controlling a shower device includes selectively actuating valves that are configured to control flow of a fluid to spray outlets of the shower device. Each of the valves is configured to control the flow of the fluid to at least one of the spray outlets, independently of other ones of the valves.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1A illustrates a front view of an example shower device.

FIG. 1B illustrates a rear view of the shower device shown in FIG. 1A.

FIG. 1C schematically illustrates a portion of the shower device of FIG. 1A.

FIGS. 1D-K schematically illustrate additional example shower devices.

FIG. 2A illustrates a cross-section of the shower device of FIG. 1A showing a plurality of independently operating valves.

FIG. 2B illustrates a cross-section of a portion of the shower device of FIG. 1A showing a plurality of chambers.

FIG. 2C illustrates a perspective view of the shower device of FIG. 1A showing the independently operating valves.

FIG. 2D illustrates the shower device of FIG. 1A without a face to show a connection between the plurality of chambers and spray outlets.

FIG. 3 illustrates another cross-section of the shower device of FIG. 1A showing an example of one of the independently operating valves in an open position.

FIG. 4 illustrates another cross-section of the shower device of FIG. 1A showing an example of one of the independently operating valves in a closed position.

FIG. 5 illustrates a cross-section of an example of one of the independently operating valves.

FIG. 6 illustrates a cross-section through a portion of one of the independently operating valves showing sloped camming surfaces.

FIG. 7 illustrates a cross-section through a portion of one of the independently operating valves showing a guide rib and guide slot of the valve.

FIG. 8A illustrates a cross-section through a portion of one of the independently operating valves showing operation of the valve.

FIG. 8B illustrates a cross-section through a portion of one of the independently operating valves showing rotation of the valve.

FIG. 9 illustrates a cross-section of a portion of the shower device of FIG. 1A showing a flow-control valve in an open position.

FIG. 10 illustrates a cross-section of a portion of the shower device of FIG. 1A showing the flow-control valve in a closed position.

FIG. 11 illustrates an independently operating valve of another example shower device in a closed position and including a static seal.

FIG. 12 illustrates an independently operating valve of another example shower device in an open position and including a static seal.

### DETAILED DESCRIPTION OF THE PREFERRED EMBODIMENT

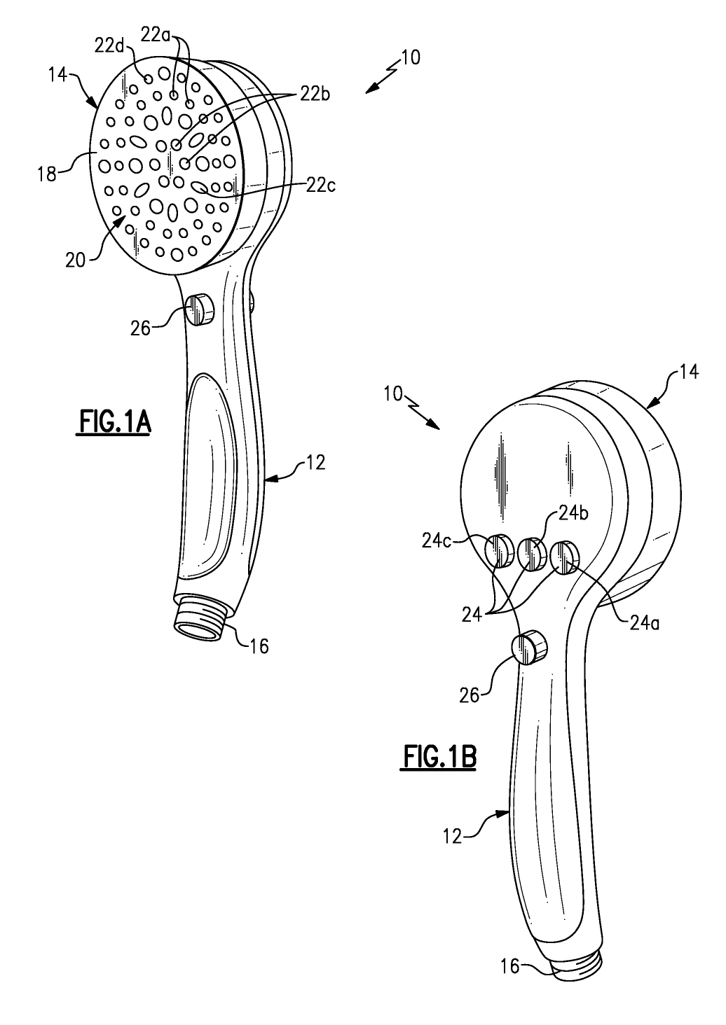

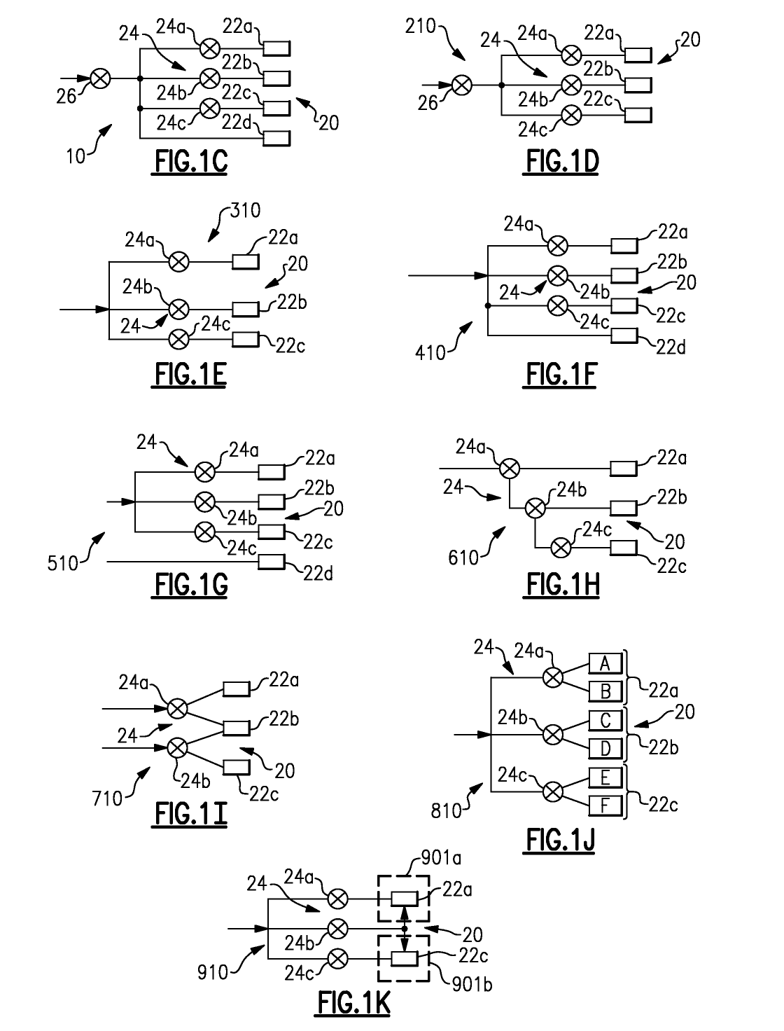

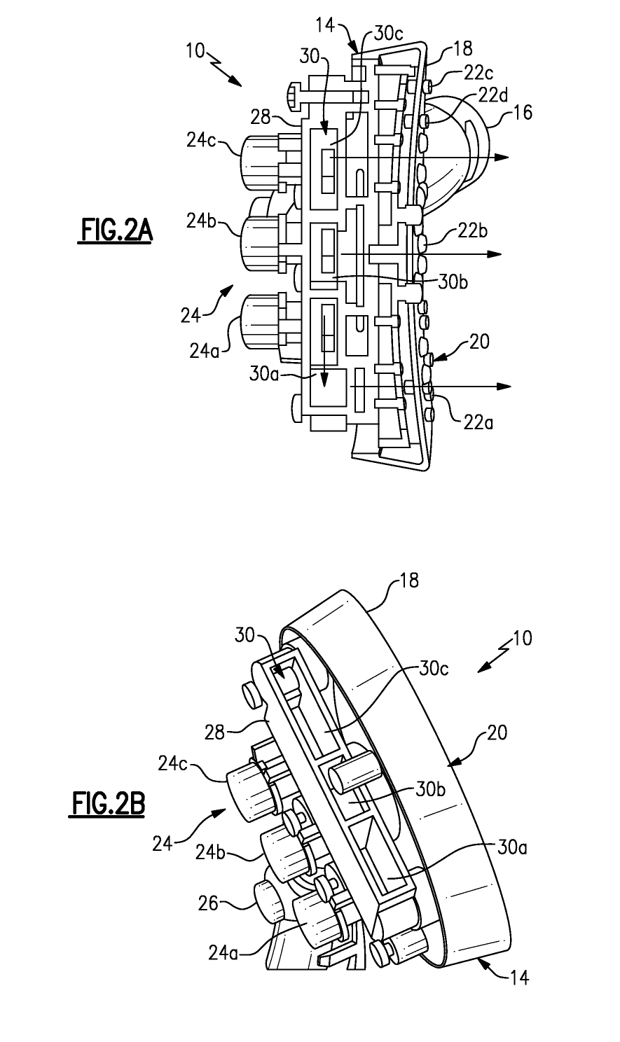

FIG. 1A illustrates selected portions of an example shower device 10 from a front view, and FIG. 1B illustrates the shower device 10 from a rear view. In the illustrated example, the shower device 10 generally includes a handle 12 for manipulating the shower device 10 and a head 14 for spraying a fluid, such as liquid water. The handle 12 may include an inlet 16 for receiving the fluid, and the head 14 includes a face 18 having a plurality of spray outlets 20. Alternatively, the shower device 10 may not include the handle 12 and may be adapted with the inlet 16 directly in the head 14 for relatively permanent fixation to a water pipe in a shower. It is to be understood that the disclosed examples are not limited to the particular design of the shower device 10 shown.

The term “spray outlets” is not intended to refer to any particular type of outlet and may include, for example only, one or more spray nozzles, fluidic nozzles, or other arrangements for emitting the fluid from the shower device 10. Additionally, it is to be understood that the spray outlets may not exclusively discharge the fluid. That is, another fluid may be added into the shower device 10 (e.g., mixed with the first fluid) prior to discharge from the spray outlets 20.

The spray outlets 20 may include groupings (i.e., a first group, a second group, etc.) of spray outlets. As an example, the spray outlets 20 may include spray outlets 22a that are outermost outlets 22a, spray outlets 22b that are innermost outlets 22b, spray outlets 22c that are intermediate outlets 22c, and spray outlets 22d that are bypass outlets 22d. Each group of spray outlets 22a-d is generally circumferentially oriented and concentric with respect to each other. It is to be understood that the disclosed example arrangement of the spray outlets 20 may vary from that shown and need not be circumferentially oriented.

The shower device 10 includes valves 24, such as valves 24a, 24b, and 24c, in selective fluid connection with the inlet 16 for controlling flow to the spray outlets 22a-c. The valves 24 may be any type of valve capable of controlling flow, such as on/off valves, diverter valves, ratchet valves, rotary valves, geared valves, rocker valves, etc. At least one of the valves 24 is configured to control, independently of the other valves 24, flow to at least one of the spray outlets 20 (i.e., one of the groups of spray outlets 22a-c). An individual valve 24 is considered independent if the control of the flow from the respective valve 24 does not rely on a state of another of the valves 24. For instance, the valve 24a can provide flow to the corresponding spray outlet 22a whether or not valves 24b and 24c are in an open, closed, or other state. Likewise, valves 24b and 24c are independent valves in this example.

As may be appreciated, additional valves 24 may be used in other examples to control spray of other groups of spray outlets. The bypass spray outlets 22d may be directly connected to the inlet 16 such that the shower device 10 always discharges spray from the bypass spray outlets 22d. Optionally, the shower device 10 may also include a flow-control valve 26 upstream of the valves 24 for controlling flow of the fluid to the valves 24 and/or spray outlets 20. The flow-control valve 26 may be capable of completely blocking flow to the valves 24 and spray outlets 20 or, alternatively, may only reduce the flow such that there is always some flow to at least a portion of the valves 24 or a portion of the spray outlets 20. In another alternative, the flow-control valve 26 may have multiple positions, such as a diverter, for controlling flow to individual ones of the valves 24 or to portions of the spray outlets 20.

FIG. 1C schematically illustrates a portion of the shower device 10 as a circuit-type diagram. A user may independently operate the valves 24 to control a spray pattern from the spray outlets 20. In this case, each of the valves 24 controls flow independently of the other valves 24. For instance, valve 24a may control flow of the fluid to the spray outlets 22a, the valve 24b may control flow of the liquid to the spray outlets 22b, and the valve 24c may control flow of the liquid to the spray outlets 22c. That is, each of the valves 24a-c may be operated to open or close flow of the fluid to the corresponding spray outlets 22a-c without regard to whether other valves 24a-c are open or closed. Thus, a user may select from a wide variety of spray patterns by actuating different combinations of the valves 24. Additionally, if the flow-control valve 26 is incorporated in the shower device 10, the user may control the intensity of the spray in combination with the different spray patterns available.

FIGS. 1D-K schematically illustrate additional example shower devices 210, 310, 410, 510, 610, 710, 810, and 910 that are variations of the shower device 10. In this disclose, like reference numerals designate like elements where appropriate, and reference numerals with the addition of one-hundred designate modified elements. It is to be understood that the modified elements incorporate the same features and benefits of the corresponding original elements, except where stated otherwise.

The shower device 210 in FIG. 1D does not include the bypass spray outlets 22d. The shower device 310 in FIG. 1E does not include the bypass spray outlet 22d or the flow-control valve 26. The shower device 410 in FIG. 1F includes the bypass spray outlet 22d but does not include the flow control valve 26. The shower device 510 in FIG. 1G does not include the flow control valve 26 but does include the bypass spray outlet 22d, which is connected to a different fluid source than the spray outlets 22a-c. In the disclosed examples, the shower devices may be connected to a single source of fluid or multiple sources, such as multiple hoses, corresponding to the respective valves 22a-c, for example.

Referring to FIG. 1H, the valves 24 of the shower device 610 are arranged differently than the prior examples. In this case, the valves 24 are arranged in series relative to the flow such that the fluid sequentially flows to valve 24a, valve 24b, and valve 24c. In this regard, valve 24a is independent of the valves 24b and 24c because the flow from valve 24a to spray outlet 22a does not rely on the state of the valves 24b or 24c. However, the valves 24b and 24c are not independent, as the flow from valves 24b and 24c to respective spray outlets 22b and 22c is dependent on whether the valve 24a is in a state that permits flow to valve 24b.

Referring to FIG. 1I, the shower device 710 includes the valves 24a and 24b. In this case, valve 24a independently controls flow to spray outlet 22a and valve 24b independently controls flow to spray outlet 22c. Spray outlet 22b is common to both valves 24a and 24b.

Referring to FIG. 1J, the shower device 810 includes the valves 24a-c. In this case, each of the valves 24a-c is a diverter valve that controls the flow between sub-groups of outlets (identified as A-F) of the spray outlets 22a-c. For instance, valve 24a selectively diverts the flow between sub-group A outlets and sub-group B outlets. Likewise, valves 24b and 24c divert flow between respective sub-groups C and D and sub-groups E and F. As can be appreciated, not all of the valves 24a-c need be diverter valves as shown.

Referring to FIG. 1K, the shower device 910 includes the valves 24a-c. In this case, the valve 24a controls flow to spray outlet 22a, which is located within a first shower head 901a. The valve 24c controls flow to spray outlet 22c, which is located within a second shower head 901b. The valve 24b controls flow to both spray outlets 22a and 22c.

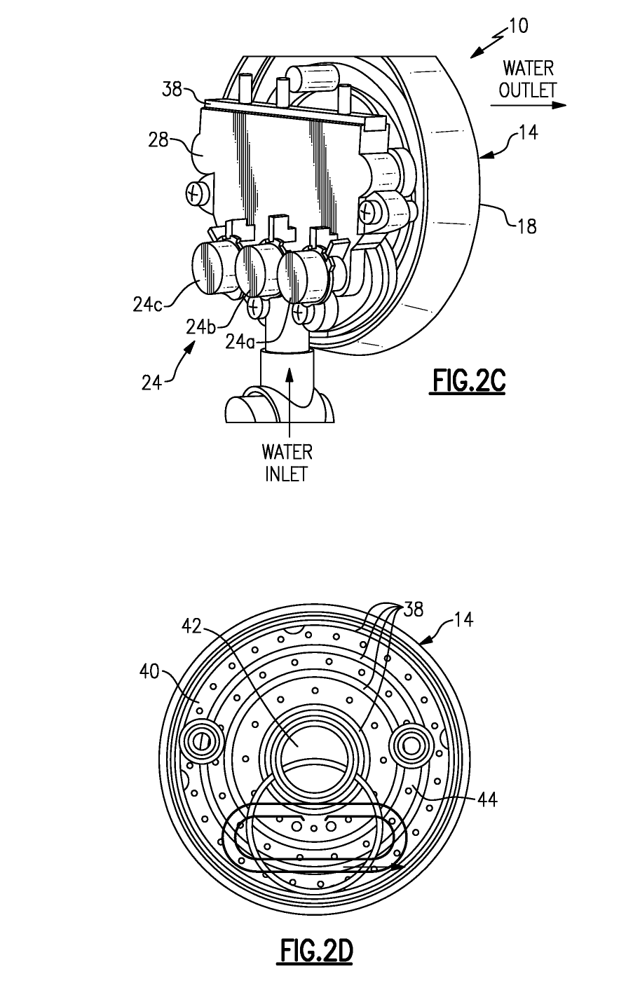

Although the following examples are made with reference to the shower device 10, it is to be understood that the examples are applicable to the shower devices 210, 310, 410, 510, 610, 710, 810, and 910. FIG. 2A illustrates a cross-section through a portion of the head 14 of the shower device 10. FIG. 2B illustrates a perspective, sectioned view of the head 14, and FIG. 2C illustrates a perspective view inside the head 14 of the shower device 10. Each of the plurality of valves 24 is received at least partially within a valve body 28 that distributes fluid from the plurality of valves 24 to the spray outlets 22a-c. For example, the valve body 28 includes a plurality of chambers 30, such as chambers 30a, 30b, and 30c corresponding exclusively to respective valves 24a, 24b, and 24c. The valve body 28 also includes a bypass passage 36 (FIG. 3) for supplying fluid to the bypass spray outlets 22d without flow through one of the plurality of valves 24.

The valve body 28 may be formed from a plastic, metal or metal alloy, such as by casting or machining, and then sealed with a cap 38. For instance, the cap 38 may be welded to the valve body 28.

FIG. 2D illustrates the head 14 of the shower device 10 without the face 18 to demonstrate the connection between the plurality of chambers 30 and the spray outlets 22a-c. For instance, the head 14 includes circumferential ridges 38 that define a first manifold 40, a second manifold 42, and a third manifold 44 that receive fluid from respective chambers 30a, 30b, and 30c to emit the fluid from respective spray outlets 22a-c.

Referring to FIG. 3, the valve body 28 includes a plurality of valve openings 50 (one shown) for receiving corresponding ones of the plurality of valves 24. In the illustrated example, the shower device 10 is cross-sectioned through valve 24b, but the other valves 24a and 24c are similarly configured. In FIG. 3, the valve 24b in an open position that permits flow of the fluid between the inlet 16 and the spray outlets 22b. For instance, the fluid flows through the flow-control valve 26 into an inlet passage 52 (as indicated by flow arrows) that is fluidly connected with each of the valves 24. The fluid flows through the valve 24b, into corresponding chamber 30b, into the second manifold 42, and then from the spray outlets 22b.

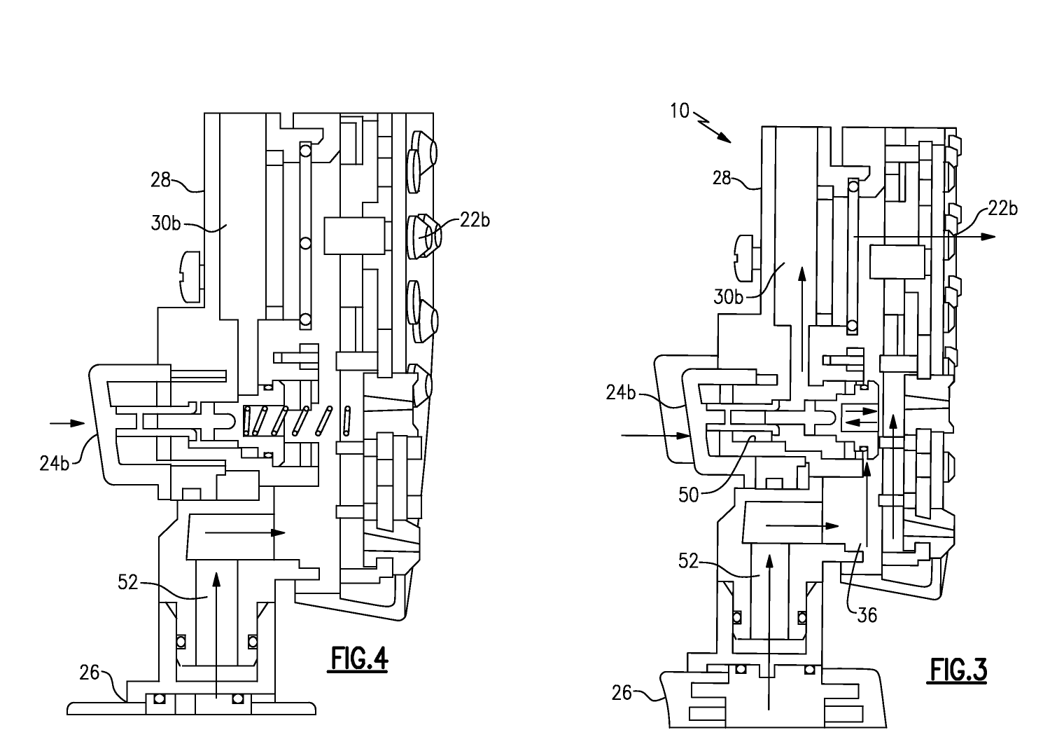

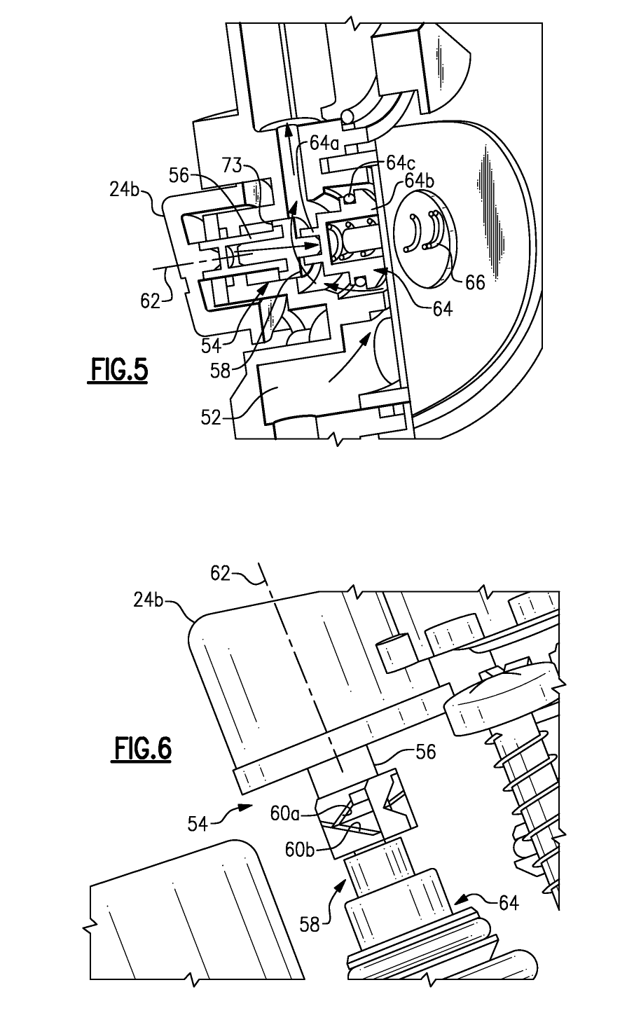

FIG. 4 illustrates the valve 24b in a closed position that blocks flow of the fluid between the inlet passage 52 and the corresponding chamber 30b. In the closed position, no fluid is sprayed from the corresponding spray outlets 22b. However, since the inlet passage 52 is also fluidly connected with the valves 24a and 24c, the spray outlets 22a and 22c may spray the fluid if the corresponding valves 24a and 24c are open. That is, the valves 24a, 24b, and 24c operate independently.

FIG. 5 illustrates an example of the valve 24b, which is also representative of valves 24a and 24c. In this example, the valve 24b is an operable, push-button valve having a push-on/push-off latch 54 for a “one-touch” operation. That is, an actuation of the valve 24b (e.g., manual actuation) causes the valve 24b to unlock from a locked state, move from a first position or a second position to, respectively, the second position or the first position, and relock to the locked state. For instance, if the valve 24b is open, a single actuation unlocks the valve 24b, moves the valve 24b from the open position to a closed position, and relocks the valve 24b in the closed position until there is another actuation. It is to be understood however, that the valves 24a-c may vary from the design shown such that the valves 24a-c do not necessarily lock in the open or closed state and/or have more than two positions to divert fluid.

Referring also to FIG. 6, the push-on/push-off latch 54 includes a cam member 56 and a valve member 58. The cam member 56 includes a sloped camming surface 60a and the valve member 58 includes a sloped camming surface 60b that cooperates with the sloped camming surface 60a to impart rotational motion of the valve 24b about a central axis 62 upon an actuation of the valve 24b, to achieve the push-on/push-off function. That is, pushing the valve 24b moves the valve 24b axially along the axis 62 and causes the sloped camming surfaces 60a and 60b to slide relative to each other and rotate about the central axis 62.

Valve member 58 also includes a valve spool 64 having a narrow end 64a for permitting flow of the fluid and wide end 64b for blocking the flow of the fluid. The wide end 64b includes an o-ring seal 64c for facilitating blocking flow in the closed position. A bias member 66, such as a coil spring, biases the valve 24b towards a default position. The default position is the closed position.

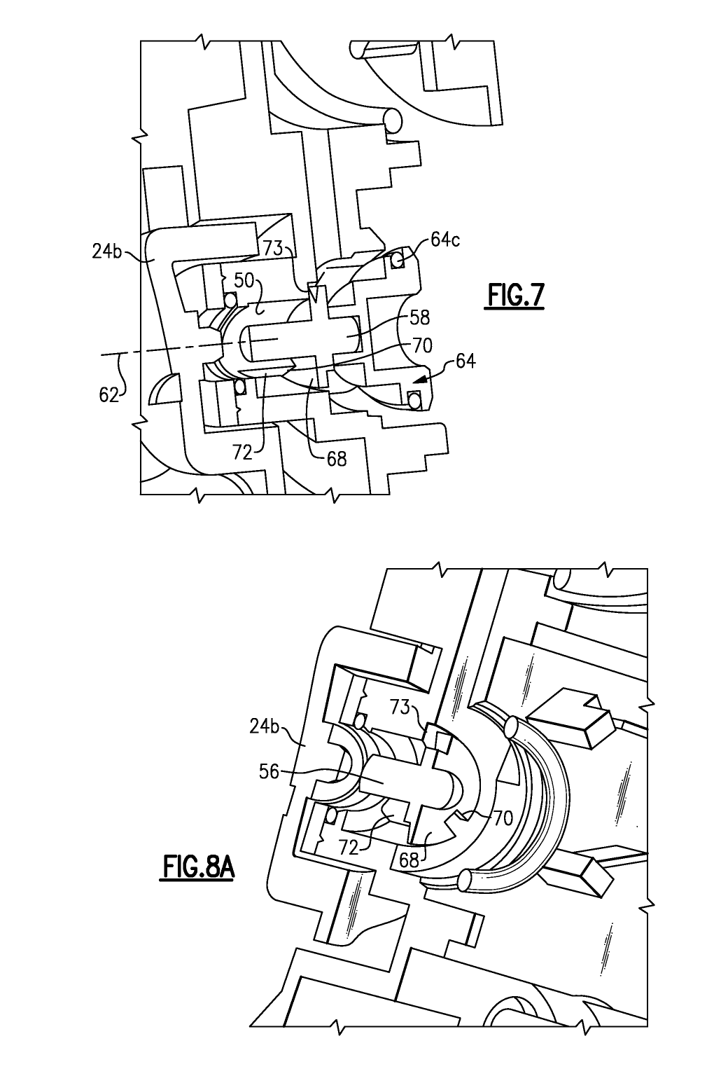

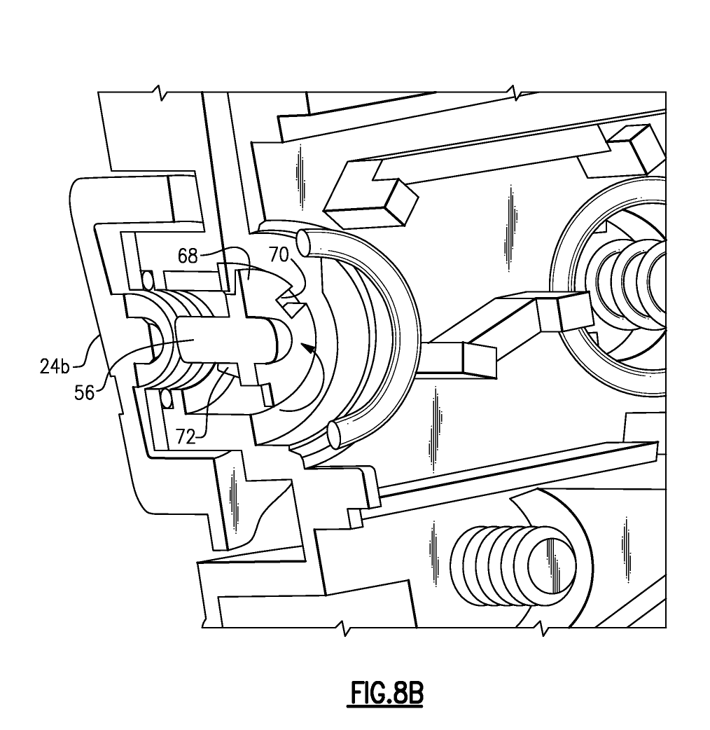

As illustrated in FIG. 7, the cam member 56 also includes a flange 68 having a radial slot 70 that interlocks with a rib 72 of the valve opening 50. The valve opening 50 may have several of the ribs 72, and the cam member 56 may have several of the slots 70 interlocked with corresponding ones of the ribs 72. The ribs 72 generally longitudinally extend within the valve opening 50, to guide axial movement of the valve 24b along the central axis 62. When the slots 70 are engaged with the ribs 72 as also shown in FIG. 8A, the cam member 56 is not permitted to rotate and simply pushes the valve member 58 axially along the central axis 62 toward the open position. When the flange 68 of the cam member 56 moves past the ends of the ribs 72, the slots 70 disengage from the ribs 72. After disengagement, the cam member 56 is free to rotate through translation along camming surface 60b of valve member 58, as shown in FIG. 8B. Rotation of the cam member 56 relative to the valve member 58 misaligns the slots 70 relative to the ribs 72 such that the cam member 56 and the valve member 58 lock in the open position. Another actuation of the valve 24b causes the camming surfaces 60a and 60b to again slide relative to one another and rotate the cam member 56 relative to the valve member 58 such that the slots 70 align with the ribs 72. Once aligned, the bias force provided by the bias member 66 moves the cam member 56 such that the slots 70 again engage the ribs 72 and slide to the closed position blocking flow of the fluid. The force of the bias member 66 then relocks the valve in the closed position (e.g., against abutment 73) until there is another actuation. As may be appreciated, other types of valves may be used instead of or in addition to the valves disclosed herein.

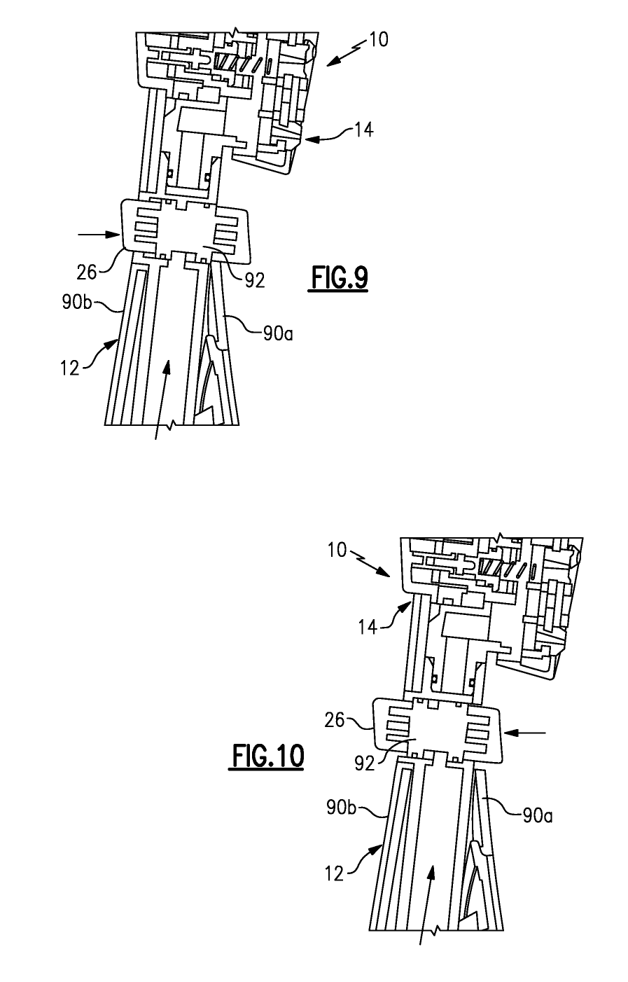

FIG. 9 illustrates an example of the flow-control valve 26 in the handle 12 of the shower device 10. In this example, the handle 10 includes a first, front side 90a and a second, opposite side 90b. The flow-control valve 26 is exposed on the front side 90a and the opposite side 90b. For instance, the flow-control valve 26 includes a valve member 92 that is movable to an open position as illustrated in FIG. 9 by moving the flow-control valve 26 from the back side 90b toward the front side 90a. The flow-control valve 26 is also exposed on the front side 90a and may be moved toward the back side 90b to move the valve member 92 to a closed position that blocks flow form the inlet 16 to the head 14 of the shower device 10. The flow control valve 26 may also be actuated to positions in between for an intermediate amount of flow. The flow-control valve 26 may be used in combination with the plurality of valves 24 to provide a desired spray intensity.

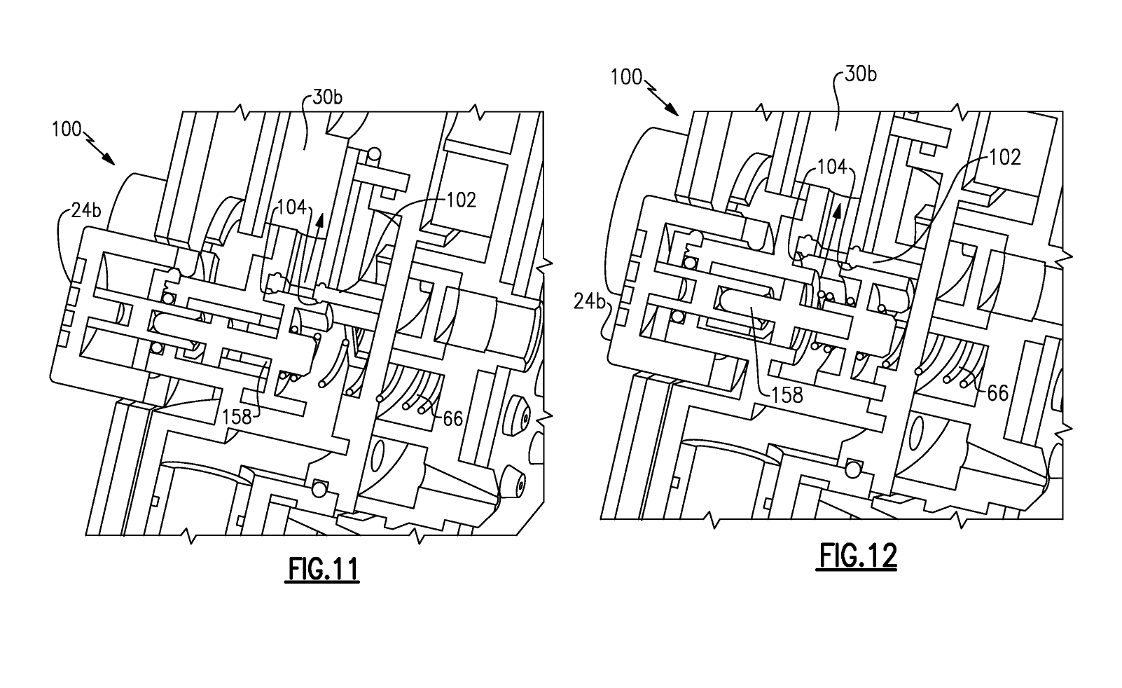

FIGS. 11 and 12 illustrate a portion of another shower device 100 that is similar to the shower device 10 of the previous examples but includes a static seal 102. In this example, the static seal 102 is located between the corresponding chamber 30b and the valve 24b. The static seal 102 includes beads 104 that protrude and seal against a valve member 158, which is similar to the valve member 58 of the previous example but does not include the o-ring seal 64c. That is, the static seal 102 is used instead of the o-ring seal 64c to facilitate blocking the flow of the fluid when the valve 24b is moved to the closed position (FIG. 11) from the open position (FIG. 12).

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A shower device comprising:
spray outlets; and
valves configured to control flow of a fluid to the spray outlets, at least one of the valves being configured to control, independently of other valves, flow of the fluid to at least one of the spray outlets.

2. The shower device as recited in claim 1, wherein the at least one of the valves is configured to control, independently of other valves, flow of the fluid to a portion of the spray outlets that includes a plurality of the spray outlets.

3. The shower device as recited in claim 1, further comprising a plurality of chambers between the spray outlets and the valves, each of the plurality of chambers being exclusively connected to a corresponding one of the valves.

4. The shower device as recited in claim 1, wherein the valves are push-button valves each including a push-on/push-off latch.

5. The shower device as recited in claim 1, further comprising a plurality of seals, each seal being adjacent a corresponding one of the valves.

6. The shower device as recited in claim 5, wherein the plurality of seals are static relative to the valves.

7. The shower device as recited in claim 1, wherein the spray outlets include at least a first group of spray outlets and a second group of spray outlets, and at least one of the valves is configured to control flow to the first group of outlets and at least another, different one of the valves is configured to control flow to the second group of outlets.

8. The shower device as recited in claim 1, wherein the spray outlets include outermost spray outlets exclusively connected to a first one of the valves, intermediate spray outlets exclusively connected to a second one of the valves, and innermost spray outlets exclusively connected to a third one of the valves.

9. The shower device as recited in claim 1, further comprising a flow-control valve located upstream of the valves relative to the flow of the fluid.

10. The shower device as recited in claim 9, wherein the flow-control valve is at least partially within a handle and includes a button that is exposed on a first side of the handle and on a second, opposite side of the handle.

11. The shower device as recited in claim 1, wherein at least one of the valves is a diverter valve.

12. The shower device as recited in claim 1, wherein at least a portion of the valves are arranged in series relative to the flow of the fluid.

13. The shower device as recited in claim 1, wherein a portion of the spray outlets are in a first shower head and another portion of the spray outlets are in a second shower head.

14. A shower device comprising:
an inlet for receiving a fluid;
spray outlets in selective fluid connection with the inlet; and
operable valves fluidly connected with the inlet, each of the operable valves being configured to selectively control, independently of other operable valves, flow of the fluid to a corresponding portion of the spray outlets, and an actuation of any one of the operable valves causes that operable valve to unlock from a locked state, move from a first position or a second position to, respectively, the second position or the first position, and then relock to the locked state.

15. The shower device as recited in claim 14, wherein the operable valves are push-button valves.

16. The shower device as recited in claim 14, wherein each operable valve is axially and rotatably moveable about a central axis in response to the actuation.

17. The shower device as recited in claim 14, wherein each of the operable valves includes a push-on/push-off latch.

18. The shower device as recited in claim 14, wherein the push-on/push-off latch includes sloped cam surfaces operable to cause rotation of the corresponding operable valve in response to the actuation.

19. The shower device as recited in claim 14, further comprising a plurality of bias members biasing respective ones of the push-button valves toward a default position.

20. The shower device as recited in claim 14, further comprising a valve body having valve openings at least partially receiving corresponding ones of the operable valves, the valve openings each including longitudinally extending ribs for guiding movement of the corresponding operable valves.

21. The shower device as recited in claim 20, wherein each of the operable valves includes slots interlocked with the corresponding ribs of the valve opening.

22. A method of controlling a shower device, comprising:
selectively actuating valves that are configured to control flow of a fluid to spray outlets of the shower device, at least one of the valves being configured to control, independently of other ones of the valves, the flow of the fluid to at least one of the spray outlets.

23. The method as recited in claim 22, further comprising selectively actuating a flow-control valve located upstream from the valves to control flow of the fluid to the valves.

24. The method as recited in claim 22, including actuating at least one of the valves to cause that valve to unlock from a locked state, move from a first position or a second position to, respectively, the second position or the first position, and then relock to the locked state.
